(19) United States
(12) Patent Application Publication
(10) Pub. No.: US 2005/0288209 A1
(43) Pub. Date: Dec. 29, 2005

(54) Cleaning compositions in the form of a tablet or granule

(76) Inventor: John Fletcher, Oakville (CA)

Correspondence Address: COLGATE-PALMOLIVE COMPANY, 909 RIVER ROAD, PISCATAWAY, NJ, 08855, US

(21) Appl. No.: 11/218,181

(22) Filed: Sep. 1, 2005

Related U.S. Application Data
(63) Continuation-in-part of application No. 10/702,683, filed on Nov. 6, 2003.

(51) Int. Cl. C11D 17/00

(52) U.S. Cl. 510/446

(57) ABSTRACT

A cleaning composition in the form of a tablet or granule comprising defined amounts of alpha hydroxyl aliphatic acid; alkali metal bicarbonate; a clay; an anionic surfactant; alkali metal carbonate; a bleach compound; and an alkali metal salt of a polycarboxylic acid polymer.

### RELATED APPLICATION

This application is a continuation-in-part application of U.S. Ser. No. 10/702,683 filed Nov. 6, 2003, the disclosure of which is incorporated herein by reference.

### FIELD OF THE INVENTION

This invention relates to a concentrate of a cleaning composition containing a surfactant coated bleach compound in the form of a tablet or granule which has excellent foam collapse properties and excellent grease cutting properties designed in particular for cleaning hard surfaces and which is effective in removing grease soil and/or bath soil and in leaving unrinsed surfaces with a shiny appearance.

### BACKGROUND OF THE INVENTION

In recent years all-purpose liquid detergents have become widely accepted for cleaning hard surfaces, e.g., painted woodwork and panels, tiled walls, wash bowls, bathtubs, linoleum or tile floors, washable wall paper, etc. Such all-purpose liquids comprise clear and opaque aqueous mixtures of water-soluble synthetic organic detergents and water-soluble detergent builder salts. In order to achieve comparable cleaning efficiency with granular or powdered all-purpose cleaning compositions, use of water-soluble inorganic phosphate builder salts was favored in the prior art all-purpose liquids.

Another approach to formulating hard surfaced or all-purpose liquid detergent composition where product homogeneity and clarity are important considerations involves the formation of oil-in-water (o/w) microemulsions which contain one or more surface-active detergent compounds, a water-immiscible solvent (typically a hydrocarbon solvent), water and a “cosurfactant” compound which provides product stability. By definition, an o/w microemulsion is a spontaneously forming colloidal dispersion of “oil” phase particles having a particle size in the range of 25 to 800 Å in a continuous aqueous phase.

In view of the extremely fine particle size of the dispersed oil phase particles, microemulsions are transparent to light and are clear and usually highly stable against phase separation.

However, since the amount of water immiscible and sparingly soluble components which can be present in an o/w microemulsion, with low total active ingredients without impairing the stability of the microemulsion is rather limited (for example, up to 18% by weight of the aqueous phase), the presence of such high quantities of grease-removal solvent tend to reduce the total amount of greasy or oily soils which can be taken up by and into the microemulsion without causing phase separation.

### SUMMARY OF THE INVENTION

The present invention provides a cleaning system comprising a concentrate of a cleaning composition in a tablet or granular form which has improved disinfecting properties and excellent foam collapse properties, and excellent grease cutting property which, when dissolved in a bucket, is suitable for cleaning hard surfaces such as plastic, vitreous and metal surfaces having a shiny finish, oil stained floors, automotive engines and other engines. More particularly, the improved cleaning compositions, with excellent foam collapse properties and excellent grease cutting property exhibit good grease soil removal properties due to the improved interfacial tensions, when used diluted and leave the cleaned surfaces shiny without the need of or requiring only minimal additional rinsing or wiping. The latter characteristic is evidenced by little or no visible residues on the unrinsed cleaned surfaces and, accordingly, overcomes one of the disadvantages of prior art products.

Surprisingly, these desirable results are accomplished even in the absence of polyphosphate or other inorganic or organic detergent builder salts and also in the complete absence or substantially complete absence of grease-removal solvent.

This invention relates to all purpose cleaning detergents in tablet or granular form which quickly dissolve to give a cleaning solution suitable for a variety of household light duty cleaning chores such as in the kitchen or bathroom, etc. The tablet or granules contain a surfactant coated bleach and an effervescent system consisting of an organic acid and sodium bicarbonate to give an efficacy signal while dissolving. In addition, the tablets or granules can also optionally contain a polymeric disintegrant which help disintegrate the tablet when added to water. The tablets can be made either as a single layer tablet with colored speckles for aesthetic benefits or can be a multi-layer tablet with different colored layers.

The invention generally provides a cleaning composition in the form of a single or multi layer tablet or granule which comprises approximately by weight:

(a) 25% to 50% of an alpha hydroxy aliphatic acid such as lactic acid or citric acid;

(b) 10% to 45% of an alkali metal bicarbonate such as sodium bicarbonate or potassium bicarbonate;

(c) 0 to 10%, more preferably 1% to 9% of a dicarboxylic acid;

(d) 0.5% to 15% of a clay;

(e) 1% to 15% of at least one anionic surfactant;

(f) 0 to 8% of a disintegration aid which is selected from the group consisting of a microcrystalline methyl cellulose and of an alkali metal salt of a polycarboxylic acid;

(g) 5% to 25% of an alkali metal carbonate;

(h) 0 to 2.5% of a precipitated silica;

(i) 0 to 3% of a polyethylene glycol;

(j) 1% to 20% of a surfactant coated bleach, nonionic surfactants and mixtures thereof;

(k) 0 to 0.3%, more preferably 0.005% to 0.3% of a blue dye or a green dye;

(l) 0 to 10 wt. %, more preferably 0.3% to 9% of an ethoxylated nonionic surfactant; and

(m) 0 to 2.5%, more preferably 0.1% to 2% of a perfume.

### DETAILED DESCRIPTION OF THE INVENTION

The present invention relates to a tablet containing a unit dose of a cleaning composition, or to cleaning granules.

A cleaning composition contained in the form of a single or multi-layered tablet or granules comprises approximately by weight:

(a) 25% to 50%, more preferably 30% to 45% of an alpha hydroxy aliphatic acid such as lactic acid or citric acid;

(b) 10% to 45%, more preferably 15% to 40% of an alkali metal bicarbonate such as sodium bicarbonate or potassium bicarbonate;

(c) 0 to 10%, more preferably 0.5% to 9% of a dicarboxylic acid;

(d) 0.5% to 15%, more preferably 1% to 13% of a clay;

(e) 1% to 15%, more preferably 2% to 13% of at least one anionic surfactant;

(f) 0 to 8%, more preferably 0.5% to 7% of a microcrystalline methyl cellulose and of an alkali metal salt of a polycarboxylic acid polymer;

(g) 5% to 25%, more preferably 7% to 20% of an alkali metal carbonate such as sodium carbonate;

(h) 0 to 2.5%, more preferably 0.1% to 2.5% of a precipitated silica;

(i) 0 to 3%, more preferably 0.1% to 3% of a polyethylene glycol having a molecular weight of 300 to 1,000;

(j) 0 to 10%, more preferably 0.3% to 9% of a nonionic surfactant;

(k) 1% to 20% of a surfactant coated bleach;

(l) 0 to 0.3%, more preferably 0.005% to 0.3% of a blue dye or green dye; and

(m) 0 to 5.0%, more preferably 0.1% to 4% of a perfume.

The present invention is predicated on the use of a cleaning tablet or cleaning granules as described herein. The preferred size of granules is in the range of from about 1 mm to about 5 mm. Tablets are generally larger in size but can be as small as about 3 mm if smaller size tablets are required.

Granules are generally more economical to produce than tablets and provide a more rapid dissolution in water due to the greater surface area provided per unit mass of granular composition. Further, granules often provide greater dosing flexibility.

As used herein and in the appended claims the term “perfume” is used in its ordinary sense to refer to and include any non-water soluble fragrant substance or mixture of substances including natural (i.e., obtained by extraction of flower, herb, blossom or plant), artificial (i.e., mixture of natural oils or oil constituents) and synthetically produced substance) odoriferous substances. Typically, perfumes are

complex mixtures of blends of various organic compounds such as alcohols, aldehydes, ethers, aromatic compounds and varying amounts of essential oils (e.g., terpenes) such as from 0% to 80%, usually from 10% to 70% by weight, the essential oils themselves being volatile odoriferous compounds and also serving to dissolve the other components of the perfume.

In the present invention the precise composition of the perfume is of no particular consequence to cleaning performance so long as it meets the criteria of water immiscibility and having a pleasing odor. Naturally, of course, especially for cleaning compositions intended for use in the home, the perftume, as well as all other ingredients, should be cosmetically acceptable, i.e., non-toxic, hypoallergenic, etc.. The nonionic surfactant which can be used in the instant cleaning composition is selected from the group of an aliphatic ethoxylated nonionic surfactant and an aliphatic ethoxylated/propoxylated nonionic surfactant and mixtures thereof.

The water soluble aliphatic ethoxylated nonionic surfactants utilized in this invention are commercially well known and include the primary aliphatic alcohol ethoxylates and secondary aliphatic alcohol ethoxylates. The length of the polyethenoxy chain can be adjusted to achieve the desired balance between the hydrophobic and hydrophilic elements.

The nonionic surfactant class includes the condensation products of a higher alcohol (e.g., an alkanol containing about 8 to 16 carbon atoms in a straight or branched chain configuration) condensed with about 4 to 20 moles of ethylene oxide, for example, lauryl or myristyl alcohol condensed with about 16 moles of ethylene oxide (EO), tridecanol condensed with about 6 to 15 moles of EO, myristyl alcohol condensed with about 10 moles of EO per mole of myristyl alcohol, the condensation product of EO with a cut of coconut fatty alcohol containing a mixture of fatty alcohols with alkyl chains varying from 10 to about 14 carbon atoms in length and wherein the condensate contains either about 6 moles of EO per mole of total alcohol or about 9 moles of EO per mole of alcohol and tallow alcohol ethoxylates containing 6 EO to 11 EO per mole of alcohol.

A preferred group of the foregoing nonionic surfactants are the Neodol ethoxylates (Shell Co.), which are higher aliphatic, primary alcohol containing about 9-15 carbon atoms, such as C₉-C₁₁ alkanol condensed with 4 to 10 moles of ethylene oxide (Neodol 91-8 or Neodol 91-5), C₁₂₋₁₃ alkanol condensed with 6.5 moles ethylene oxide (Neodol 23-6.5), C₁₂₋₁₅ alkanol condensed with 12 moles ethylene oxide (Neodol 25-12), C₁₄₋₁₅ alkanol condensed with 13 moles ethylene oxide (Neodol 45-13), and the like. Such ethoxamers have an HLB (hydrophobic lipophilic balance) value of about 8 to 15 and give good O/W emulsification, whereas ethoxamers with HLB values below 7 contain less than 4 ethyleneoxide groups and tend to be poor emulsifiers and poor detergents.

Additional satisfactory water soluble alcohol ethylene oxide condensates are the condensation products of a secondary aliphatic alcohol containing 8 to 18 carbon atoms in a straight or branched chain configuration condensed with 5 to 30 moles of ethylene oxide. Examples of commercially available nonionic detergents of the foregoing type are C₁₁-C₁₅ secondary alkanol condensed with either 9 EO (Tergitol 15-S-9) or 12 EO (Tergitol 15-S-12) marketed by Union Carbide.

Suitable water-soluble non-soap, anionic surfactants used in the instant compositions include those surface-active or detergent compounds which contain an organic hydrophobic group containing generally 8 to 26 carbon atoms and preferably 10 to 18 carbon atoms in their molecular structure and at least one water-solubilizing group selected from the group of sulfonate, sulfate and carboxylate so as to form a water-soluble detergent. Usually, the hydrophobic group will include or comprise a C₈-C₂₂ alkyl, alkyl or acyl group. Such surfactants are employed in the form of water-soluble salts and the salt-forming cation usually is selected from the group consisting of sodium, potassium, ammonium, magnesium and mono-, di- or tri-C₂-C₃ alkanolammonium, with the sodium, magnesium and ammonium cations again being preferred. The preferred sulfate surfactants are C₁₂-C₁₈ alkyl sulfate surfactants.

Examples of suitable sulfonated anionic surfactants for use in the instant compositions are the well known higher alkyl mononuclear aromatic sulfonates such as the higher alkyl benzene sulfonates containing from 10 to 16 carbon atoms in the higher alkyl group in a straight or branched chain, C₈-C₁₅ alkyl toluene sulfonates and C₈-C₁₅ alkyl phenol sulfonates.

A preferred sulfonate is linear alkyl benzene sulfonate having a high content of 3—(or higher) phenyl isomers and a correspondingly low content (well below 50%) of 2—(or lower) phenyl isomers, that is, wherein the benzene ring is preferably attached in large part at the 3 or higher (for example, 4, 5, 6 or 7) position of the alkyl group and the content of the isomers in which the benzene ring is attached in the 2 or 1 position is correspondingly low. Particularly preferred materials are set forth in U.S. Pat. No. 3,320,174.

Other suitable anionic surfactants are the olefin sulfonates, including long-chain alkene sulfonates, long-chain hydroxyalkane sulfonates or mixtures of alkene sulfonates and hydroxyalkane sulfonates. These olefin sulfonate detergents may be prepared in a known manner by the reaction of sulfur trioxide (SO₃) with long-chain olefins containing 8 to 25, preferably 12 to 21 carbon atoms and having the formula RCH═CHR₁ where R is a higher alkyl group of 6 to 23 carbons and R₁ is an alkyl group of 1 to 17 carbons or hydrogen to form a mixture of sultones and alkene sulfonic acids which is then treated to convert the sultones to sulfonates. Preferred olefin sulfonates contain from 14 to 16 carbon atoms in the R alkyl group and are obtained by sulfonating an a-olefin.

A preferred tablet or granule will contain 1 wt. % to 8 wt. % of a C₁₂-C₁₈ alkyl sulfate surfactant and 0 to 5 wt. %, more preferably 1 wt. % to 4 wt. % of a C₁₀-C₁₆ linear alkyl benzene sulfonate surfactant.

The sodium carbonate used in the instant compositions can be either a light density sodium carbonate (density 0.50 to 0.58 g/ml) or a dense density sodium carbonate (density 1.0 to 1.1 g/ml) or mixtures of the light density sodium carbonate and the dense density sodium carbonate in a weight ratio of 5:1 to 1:5.

The precipitated silica is a hydrophilic silica having free hydroxyl groups on its surface and spherical shaped particles having a particle size of less than about 100 millimicrons. A preferred precipitated silica is Sipernat 22S™ manufactured by DeGussa.

The dicarboxylic acids used in the instant tablets have the formula:
HO₂C—(CH₂—CH₂)ₙ—CO₂—H
wherein n is a number between 4 and 6.

A preferred dicarboxylic acid is adipic acid. The clays which used in the instant compositions are the inorganic, colloid-forming clays of smectite and/or attapulgite types. Smectite clays include montmorillomite (bentonite), hectorite, smectite, saponite, and the like. Montmorillonite clays are available under tradenames such as Thixogel (Registered trademark) No. 1 and Gelwhite (Registered trademark) GP, H, etc., from Georgia Kaolin Company; and ECCAGUM (Registered trademark) GP, H, etc., from Luthern Clay Products. Attapuligite clays include the materials commercially available under the tradename Attagel (Registered trademark), i.e. Attagel 40, Attagel 50 and Attagel 150 from Engelhard Minerals and Chemicals Corporation. Mixtures of smectite and attapulgite types in weight ratios of 4:1 to 1:5 are also useful herein. Another clay is a bentonite clay containing a blue, green or pink dye which is manufactured by Larivosa Chimica Mineraria, S.p.A. and manufactured under the name of Detercal P4™. A most preferred clay is Laponite RD clay manufactured by Southern Clay.

Any chlorine bleach compound can be surfactant coated and may be employed in the compositions of this invention, such as dichloroisocyanurate, dichlorodimethylhydantoin, or chlorinated TSP. The composition should contain sufficient chlorine bleach compound to provide about 0.2 to 4.0% by weight of available chlorine, as determined, for example, by acidification of 100 parts of the composition with excess hydrochloric acid. The preferred bleach is sodium dichloroisocyanurate dihydrate which is used at a concentration of 0.2% to 5%, more preferably 0.5% to 4% by weight of the total weight of the tablet.

The alkali metal salt of the crosslinked polyacrylic acid polymer has the structure of: 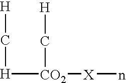
wherein n is a number sufficient to provide a polymer with a molecular weight of about 400,000 to about 2,000,000, more preferably about 400,000 to about 1,500,000 and X is an alkali metal or alkaline earth metal cation. A preferred crosslinked polyacrylic acid polymer is Acusol 771™ manufactured by the Rohm and Haas Company.

A solubilizing agent can be optionally used at a concentration of 0.1% to 8% by weight. The solubilizing agent enhances the solubility of the tablet in the water during when added to water. The solubilizing agent is a crosslinked N-2-polyvinyl pyrrolidone having a particle size of 15 to 125 microns. The polyvinyl pyrrolidone is manufactured by International Speciality Corp. under the tradename Polyplasdone™ XL (100 microns) or Polyplasdone™ XL-10 (30 microns).

A lubricant can be used to improve the process for manufacturing the tablet by improving the release of the tablet from the mold during the manufacture. The lubricant is an alkali metal salt of a fatty acid having 8 to 22 carbon atoms such as sodium stearate magnesium stearate or potassium stearate and is used at a concentration of 0.05 to 2 wt. %, more preferably 0.1 to 1.0 wt. %.

The cleaning composition of this invention may, if desired, also contain other components either to provide additional effect or to make the product more attractive to the consumer. The following are mentioned by way of example: Colors or dyes in amounts up to 0.5% by weight; bactericides in amounts up to 1% by weight; preservatives or antioxidizing agents, such as formalin, 5-bromo-5-nitro-dioxan-1,3; 5-chloro-2-methyl-4-isothaliazolin-3-one, 2,6-di-tert.butyl-p-cresol, etc., in amounts up to 2% by weight. In final form, the cleaning compositions which contain less than 5 wt. % of water exhibit stability at reduced and increased temperatures.

The process for making the tablets of the invention comprises the step of compacting or compressing dry blended formula amounts of powders with an overspray of the liquid nonionic and fragrance. Any needed color solutions are also sprayed at this time and then the resulting powder is run through a tablet press which has molds to prepare tablets of desired shape, size and weight. The powders are added to the mixer (twin shell or other appropriate mixer).

The powder is then fed to a rotary press having typically from about 19 to about 30 molds. Tablets are pressed at a high speed (5 per second). As they exit the press, they are channeled to the packaging line. The tablets can be generally any shape but preferably elliptical in shape or the tablets can be elongated in shape with curved ends such as an oval shape or even circular, square or rectangular.

The production of granules in accordance with the invention involves a compaction composition step which can be a tabletting step but preferably is a granulation process or a briquetting process which are faster and generally more economical processes than a tabletting operation. Following the compaction step there is a milling step which effectively breaks up the compacted material, and finally there is a sieving step to obtain particles in the size range of interest. The formation of tablets and granules are carried out using processes and equipment well known in the art for such purpose.

The preferred size of granules for purpose of the invention is generally from about 1 mm to about 5 mm, and tablets being generally larger than 5 mm in size, but could be as small as about 3 mm if required.

The following examples illustrate liquid cleaning compositions of the described invention. Unless otherwise specified, the proportions in the film and elsewhere in the specification are by weight.

### EXAMPLE 1

The following formulas were prepared in wt. % by simple mixing and then formed into a tablet:

| | A | B | C | D | E | F | G |
|---|---|---|---|---|---|---|---|
| Na alkyl sulfate C12-18 | 5.00% | 5.00% | 5.00% | 5.00% | 0.00% | 4.00% | 3.00% |
| Na alkyl benzene sulfonate | | | | | | | 2.00% |
| Nonionic surfactant | | | | 1.00% | 2.75% | 1.00% | |
| Perfume | 0.70% | 1.25% | 1.50% | 1.25% | 1.25% | 2.50% | 2.50% |
| Citric acid - anhydrous | 31.25% | 31.25% | 31.25% | 31.25% | 31.00% | 30.00% | 30.00% |
| Adipic acid | 7.50% | 7.50% | 7.50% | 7.50% | 9.00% | 7.50% | 7.50% |
| Sodium bicarbonate | 33.20% | 32.38% | 32.00% | 31.38% | 37.50% | 15.74% | 16.24% |
| Sodium carbonate - dense | 7.00% | 7.00% | 7.00% | 7.00% | 10.00% | 22.50% | 22.50% |
| Sodium carbonate - light | | | | | | | |
| Surfactant-coated Na | 10.00% | 10.00% | 10.00% | 10.00% | 0.00% | 10.00% | 10.00% |
| dichloroisocyanurate | | | | | | | |
| Bentonite clay | 5.00% | 5.00% | 5.00% | 4.50% | 4.50% | 5.00% | 5.00% |
| Precipitated silica | 0.35% | 0.63% | 0.75% | 1.13% | 2.00% | 1.75% | 1.25% |
| PEG4000 | 0.00% | 0.00% | 0.00% | 0.00% | 2.00% | | |
| Sipemat 22 | | | | | | | |
| Vasagel K clay | | | | | | | |
| Acusol 771 | | | | | | | |
| Acusol 772 | | | | | | | |
| Vibracolour blue dye | | | | | | 0.01% | 0.01% |
| Vivapur 200 cellulose | | | | | | | |
| Arbocel TF0412 cellulose | | | | | | | |
| Hardness (N) | 100-130 | 100-130 | 90-100 | 90-110 | 60-70 | 80-100 | 60-80 |
| Dissolution time (min.) | 2.48 | 6.15 | 3.50 | 6.40 | 7.50 | 8.40 | 8.00 |
| Processability | OK | OK | OK | OK | OK | OK | OK |
| Foam Profile (mm) T = 0 min. | 30 | 28 | 26 | 45 | 41 | 111 | 111 |
| Foam Profile (mm) T = 10 min. | 22 | 15 | 19 | 34 | 20 | 41 | 41 |
| | H | I | J | K | L | M | N |
| Na alkyl sulfate C12-18 | 4.00% | 4.00% | 4.50% | 5.00% | 2.00% | 2.00% | 2.00% |
| Na alkyl benzene sulfonate | | | | | 3.00% | 3.00% | 3.00% |
| Nonionic surfactant | 1.00% | 1.00% | 1.00% | 1.00% | 0.50% | 0.50% | 0.50% |
| Perfume | 2.50% | 2.50% | 2.50% | 2.50% | 2.50% | 2.50% | 2.50% |
| Citric acid - anhydrous | 37.50% | 37.50% | 37.50% | 37.50% | 36.26% | 36.26% | 35.26% |
| Adipic acid | | | | | | | |
| Sodium bicarbonate | 15.74 | 20.74% | 20.24% | 19.74% | 23.13% | 23.13% | 23.13% |
| Sodium carbonate - dense | 22.50% | 17.50% | 17.50% | 17.5 | 5.00% | 5.00% | 5.00% |
| Sodium carbonate - light | | | | | 10.00% | 10.00% | 10.00% |
| Surfactant-coated Na | 10.00% | 10.00% | 10.00% | 10.00% | 10.00% | 10.00% | 10.00% |
| dichloroisocyanurate | | | | | | | |
| Bentonite clay | 5.00% | 5.00% | 5.00% | 5.00% | | | |
| Precipitated silica | 1.75% | 1.75% | 1.75% | 1.75% | | | |
| PEG4000 | | | | | 1.00% | 1.00% | 1.00% |
| Sipemat 22 | | | | | 0.60% | 0.60% | 0.60% |
| Vasagel K clay | | | | | 5.00% | 5.00% | 5.00% |
| Acusol 771 | | | | | 1.00% | 1.00% | 1.00% |
| Acusol 772 | | | | | | | |
| Vibracolour blue dye | 0.01% | 0.01% | 0.01% | 0.01% | 0.02% | 0.02% | 0.02% |
| Vivapur 200 cellulose | | | | | | | 1.00% |
| Arbocel TF0412 cellulose | | | | | | | |
| Hardness (N) | 60-80 | 60-80 | 60-80 | 60-80 | 60 | 65 | 107 |
| Dissolution time (min.) | <5.00 | <5.00 | <5.00 | <5.00 | 4.00 | 4.10 | 3.28 |
| Processability | OK | OK | OK | OK | OK | OK | OK |
| Foam Profile (mm) T = 0 min. | 56 | 51 | 91 | 101 | 79 | 86 | 56 |
| Foam Profile (mm) T = 10 min. | 31 | 21 | 51 | 51 | 51 | 31 | 26 |

| | O | P | Q | R |
|---|---|---|---|---|
| Na alkyl sulfate C12-18 | 2.00% | 2.00% | 2.00% | 2.00% |
| Na alkyl benzene sulfonate | 3.00% | 3.00% | 3.00% | 3.00% |
| Nonionic surfactant | 0.50% | 0.50% | 0.50% | 0.50% |
| Perfume | 2.50% | 2.50% | 2.50% | 2.50% |
| Citric acid - anhydrous | 34.26% | 36.26% | 36.26% | 36.25% |
| Adipic acid | | | | |
| Sodium bicarbonate | 23.13% | 22.13% | 21.13% | 21.64% |
| Sodium carbonate - dense | 5.00% | 5.00% | 5.00% | 10.00% |
| Sodium carbonate - light | 10.00% | 10.00% | 10.00% | 5.00% |
| Surfactant-coated Na dichloroisocyanurate | 10.00% | 10.00% | 10.00% | 10.00% |
| Bentonite | | | | |
| Precipitated silica | | | | |
| PEG4000 | 1.00% | 1.00% | 1.00% | 1.00% |
| Sipemat 22 | 0.60% | 0.60% | 0.60% | 1.10% |
| Vasagel K clay | 5.00% | 5.00% | 5.00% | 5.00% |
| Acusol 771 | 1.00% | 1.00% | 1.00% | 1.00% |
| Acusol 772 | | | | |
| Vibracolour blue dye | 0.02% | 0.02% | 0.02% | 0.02% |
| Vivapur 200 cellulose | 1.00% | | | 1.00% |
| Arbocel TF0412 cellulose | | 1.00% | 2.00% | |
| Hardness (N) | 110 | 90 | 68 | 70 |
| Dissolution time (min.) | 3.46 | 4.16 | 4.20 | 3.20 |
| Processability | OK | OK | OK | OK |
| Foam Profile (mm) T = 0 min. | 71 | 76 | 86 | 66 |
| Foam Profile (mm) T = 10 min. | 36 | 36 | 31 | 31 |

The tablets containing the above formulas were dissolved in three minutes in 2 L of water in a vessel. This formula generates foam during dissolution and subsequent use.

1. A cleaning composition in the form of a tablet or granule which comprises approximately by weight:
(a) 25% to 50% of an alpha hydroxy aliphatic acid;
(b) 10% to 45% of an alkali metal bicarbonate;
(c) 0.5% to 15% of a clay;
(d) 1% to 10% of at least one anionic surfactant;
(e) 0.5% to 7% of an alkali metal salt of a polycarboxylic acid polymer;
(f) 5% to 25% of an alkali metal carbonate; and
(g) 1% to 20% of a surfactant coated bleach compound.

2. A cleaning composition according to claim 1 further including a nonionic surfactant.

3. A cleaning composition according to claim 2, wherein said clay is a Laponite clay.

4. A cleaning composition according to claim 1, further including a polyethylene glycol.

5. A cleaning composition according to claim 1, further including a perfumie.

6. A cleaning compostion according to claim 1, further including a precipitated silica.

7. A cleaning composition according to claim 1, in the form of a single layer tablet.

8. A cleaning tablet according to claim 1, wherein said tablet comprises multi-layers.

9. A cleaning composition according to claim 1, further including a dicarboxylic acid.

10. A cleaning tablet or granule according to claim 1 further including a colored dye.

11. A cleaning composition according to claim 1, wherein said bleach compound is sodium dichloroisocyanurate.

12. A method of cleaning a hard surface comprising the step of contacting the surface to be cleaned with an effective amount of a cleaning composition in accordance with any of claims 1-11.
